(19) United States
(12) Patent Application Publication
(10) Pub. No.: US 2012/0082955 A1
(43) Pub. Date: Apr. 5, 2012

(54) SALIVA SUCTION SYSTEM

(76) Inventor: Chen-Chia Yang, Taichung (TW)

(21) Appl. No.: 12/895,054

(22) Filed: Sep. 30, 2010

(51) Int. Cl. A61C 17/06

(52) U.S. Cl. 433/91

(57) ABSTRACT

A saliva suction system includes a suction head, a container, a pump, a controller and two tubes. The suction head has an outline fitting a lower jaw. The suction head is provided with a plurality of inlet holes and an outlet hole. The inlet holes communicate with the outlet hole. The tubes are separately disposed between the pump and the suction head and between the pump and the container. The controller makes the pump turn on or off. The saliva suction system further includes a timer and a sensor for automatic or intermittent control.

### BACKGROUND OF THE INVENTION

1. Technical Field

The invention relates to saliva suction systems, particularly to long time use/fulltime use, automatic/manual saliva suction systems with respect to saliva quantity.

2. Related Art

There are many reasons causing dysphagia, including:

a) Pharyngeal lesion, such as pharyngitis: Pharyngitis usually results in a severely sore throat, so patients who contract pharyngitis always feel painful when they are swallowing.

b) Symptom of brain lesions, such as apoplexy: These patients usually slobber because of swallowing dysfunction. This will invite obnoxious odor, poor impression and risk of lung infection.

The quality of life and health of those slobbering patients will be adversely affected if the symptom is not properly treated.

Additionally, the dental saliva suckers may be available, but they are not really suitable for the abovementioned patients because:

1. The dental saliva suckers are a kind of large and professional equipment not for home use or portable use.

2. A suction head of the dental saliva sucker is also tube-like without a suction head which may be put in mouth, so it only can suck the saliva near the suction head. If a user wants to suck saliva completely, he/she must continuously move the suction head in a patient's mouth.

3. The dental saliva suckers only can be turned on and off but cannot be automatically operated, so they are unsuitable for prolonged use.

### SUMMARY OF THE INVENTION

A primary object of the invention is to provide a saliva suction system which can be automatically controlled and adjusted.

A secondary object of the invention is to provide a saliva suction system which can be intermittently functioned with adjustable time gap, duration and suction strength. Of course, the saliva suction system of the invention also can be continuously functioned.

Another object of the invention is to provide a saliva suction system can be manually operated to turn on or off for emergency.

Still another object of the invention is to provide a saliva suction system which can compute the sucked saliva quantity in a unit time for medical statistics, analysis and record.

To accomplish the above object, the saliva suction system includes a suction head, a container, a pump, a controller and two tubes. The suction head has an outline fitting a lower jaw. The suction head is provided with a plurality of inlet holes and an outlet hole. The inlet holes communicate with the outlet hole. The tubes are separately disposed between the pump and the suction head and between the pump and the container. The controller makes the pump turn on or off. The saliva suction system further includes a timer and a sensor for automatic or intermittent control.

According to the invention, the saliva suction system further comprises a sensor for detecting saliva and sending a signal to the controller. The pump can be automatically operated by the controller according to the signal from the sensor.

According to the invention, the saliva suction system further comprises a sensor, wherein the controller continuously has the pump turn on or adjust the strength of suction when the sensor also continuously detects existence of saliva, and the controller instantly or delayedly turns off the pump when the sensor does not detect any saliva. Thus an automatic adjustment can be obtained.

According to the invention, the controller has a timer by which an intermittent operation of the pump is performed. Thus the work period and rest period can be controlled by the timer.

According to the invention, the saliva suction system further comprises a switch set composed of a normally open switch and a normally close switch, wherein the normally open switch connects to the pump in series, the controller connects to the normally close switch in series and then connects to the normally open switch in parallel. Thus the pump may be immediately turned on or off for an emergency.

According to the invention, the suction head is formed by an upper flat surface and a lower cambered surface, a front side and rear side of the suction head are formed with a recess and a rear convex arc respectively, a left side and right side of the suction head are formed with a left convex arc and a right convex arc respectively. This shape may provide more suitable for being held in mouth.

According to the invention, the suction head is made of silicone. Silicone is with flexibility and no toxicity and very suitable for be held in mouth.

According to the invention, the controller has a display for showing a suction time, suction quantity and other information.

According to the invention, the sensor is a flow meter by which a saliva quantity can be recorded for analysis.

According to the invention, the container has an entrance and a cap for sealing up an opening. And the container is provided with a scale for indicating saliva volume. This will be convenient to record the saliva quantity.

### BRIEF DESCRIPTION OF THE DRAWINGS

FIG. 1 shows a system arrangement of the preferred embodiment of the invention;

FIG. 2 is a block diagram of control of the preferred embodiment of the invention;

FIG. 3 is a circuit diagram of control of the preferred embodiment of the invention;

FIG. 4 is a perspective view of the suction head of the preferred embodiment of the invention;

FIG. 4A is a top plan view of the suction head;

FIG. 4B is a side plan view of the suction head;

FIG. 4C is a rear plan view of the suction head;

FIG. 5 is a perspective view of the controller;

FIG. 6 is a cross-sectional view of the controller; and

FIG. 7 is a schematic view of the suction head placed in a lower jaw.

### DETAILED DESCRIPTION OF THE INVENTION

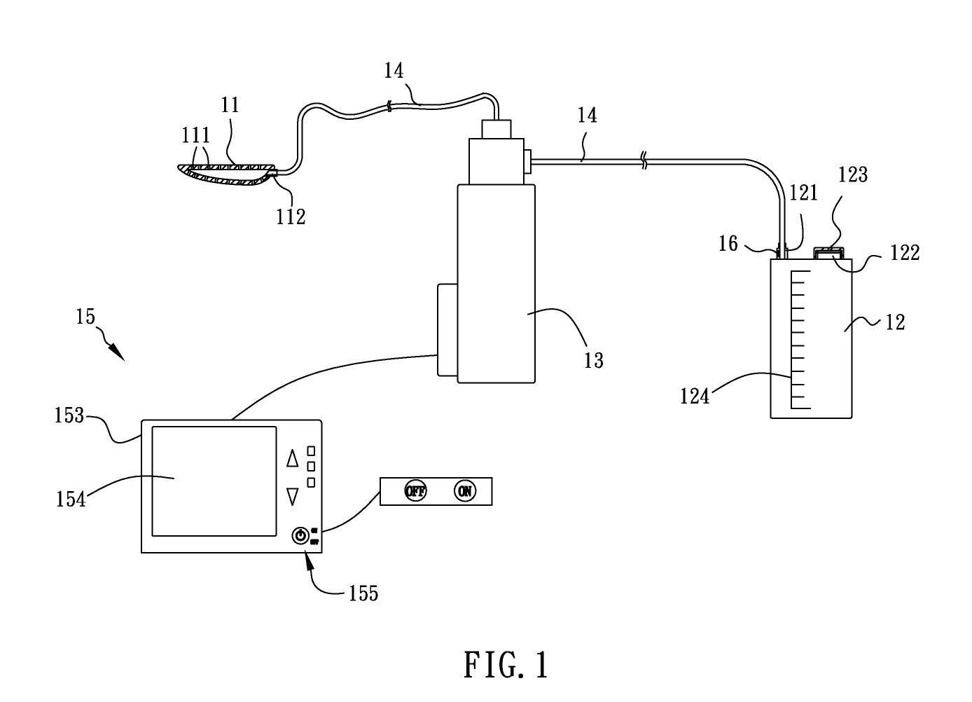

Please refer to FIG. 1. The saliva suction system of the invention includes a suction head 11, a container 12, two tubes 14 and a controller 15.

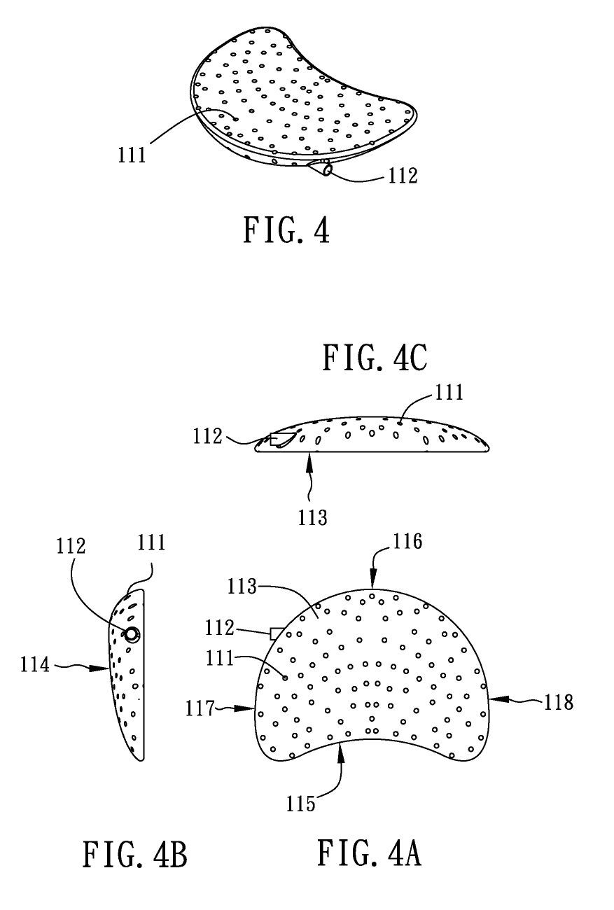

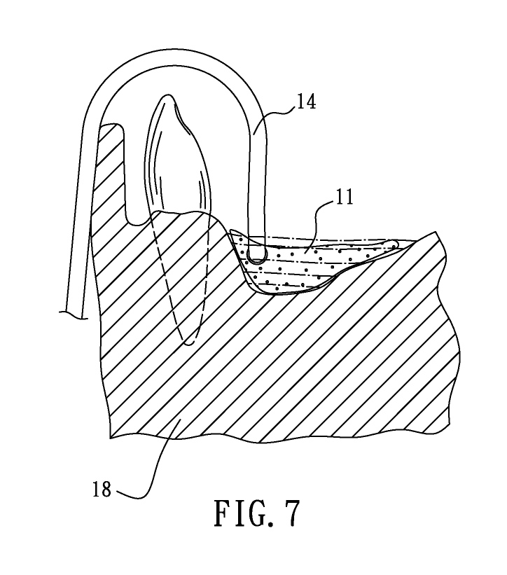

Please refer to FIGS. 4 and 4A-4C. The suction head 11 has a flat outline fitting a lower jaw of mouth, so that it may be placed in a mouth of a patient. The suction head 11 is provided with a plurality of inlet holes 111 and at least one outlet hole 112. The inlet holes 111 communicate with the outlet hole 112. In the shown embodiment, the suction head 11 is formed by an upper flat surface 113 and a lower cambered surface 114. The front side and rear side of the suction head 11 are formed with a recess 115 and a rear convex arc 116, respectively. The left side and right side of the suction head 11 are formed with a left convex arc 117 and a right convex arc 118, respectively. As shown in FIG. 7, when the suction head 11 is placed in a mouth, the bottom of the suction head 11 just clings onto a lower jaw, the recess 115 of the suction head 11 nears a tongue root, the left convex arc 117 and right convex arc 118 near the teeth on both sides, and the rear convex arc 116 nears the front teeth. Thus, the suction head 11 is always held in the lower jaw no matter when the patient is standing, sitting or laying down so as to efficiently suck saliva. Additionally, the suction head 11 may be preferably made of silicone with flexibility and no toxicity. This will make the patients holding the suction head 11 in their mouths feel less uncomfortable than ever.

The tubes 14 are separately disposed between the pump 13 and the suction head 11 and between the pump 13 and the container 12. The controller 15 makes the pump 13 turn on or off. Saliva in the mouth will be sucked into the suction head 11 through the inlet holes 111 and ejected out from the outlet hole 112. The saliva ejected from the outlet hole 112 will be transferred into the container 12 via the tube 14.

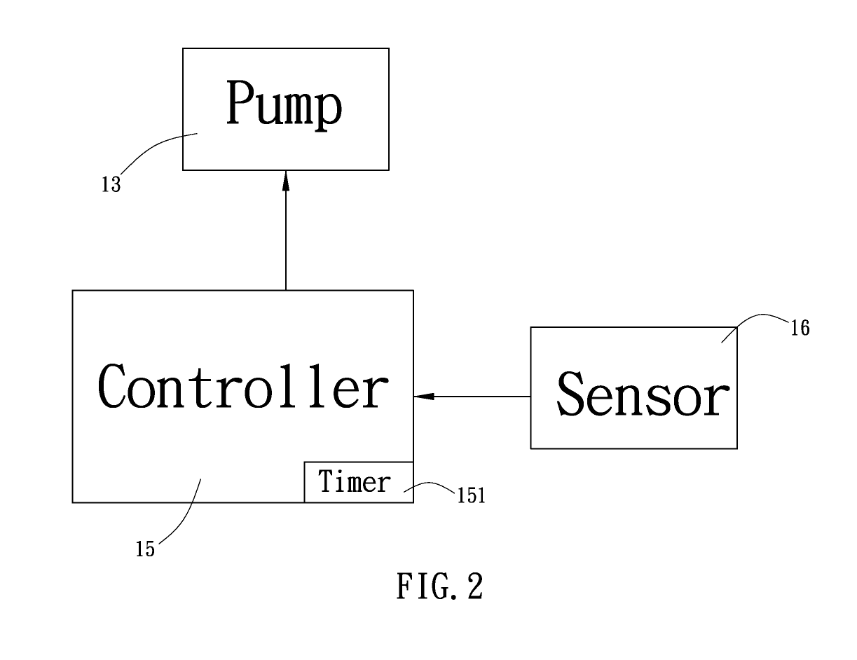

As abovementioned and shown in FIG. 2, the controller 15 further includes a timer 151 for intermittent suction. And the time gap of the intermittence may be adjusted according to the timer 151.

Additionally, the invention further includes a sensor 16 for detecting saliva. The controller 15 may switch the pump 13 on /off according to the sensor 16. Of course, the controller 15 may continuously have the pump 13 turn on when the sensor 16 also continuously detects the existence of saliva. On the contrary, the controller 15 may instantly or delayedly turn off the pump 13 when the sensor 16 does not detect any saliva. Thus, an automatic control can be obtained. Preferably, the sensor 16 is a flow meter disposed at a position through which saliva will flow. In this embodiment, the sensor 16 is fixed in an entrance 121 of the container 12. The sensor 16 detects the saliva to send a signal to the controller 15.

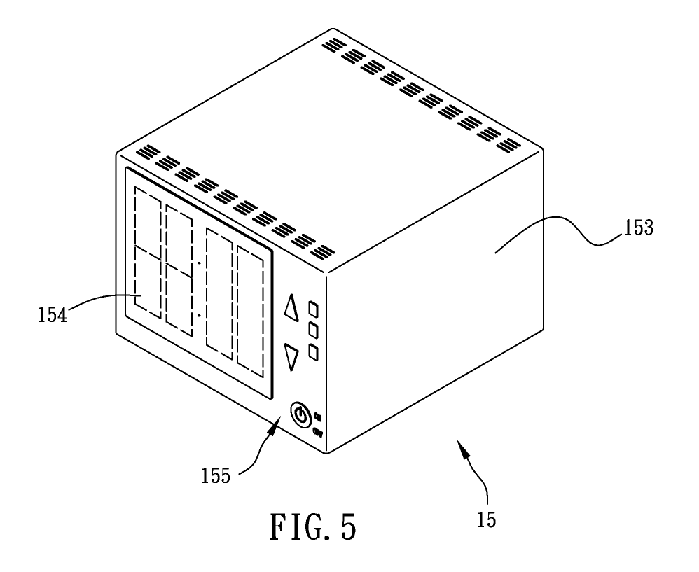

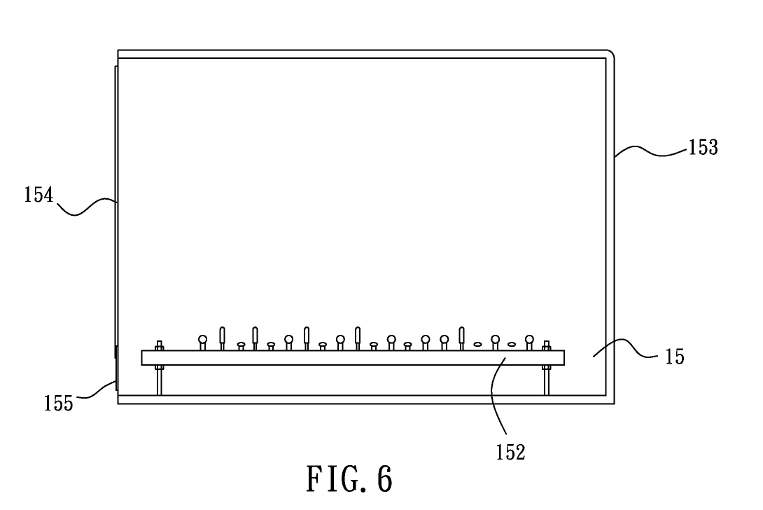

Please refer to FIGS. 5 and 6. The controller 15 and timer 151 are composed of electric circuits and disposed on a circuit board 152. The controller 15 is provided with a housing 153. There is a display 154 for showing suction time, suction quantity and other information and keys 155 for inputting data on the housing 153.

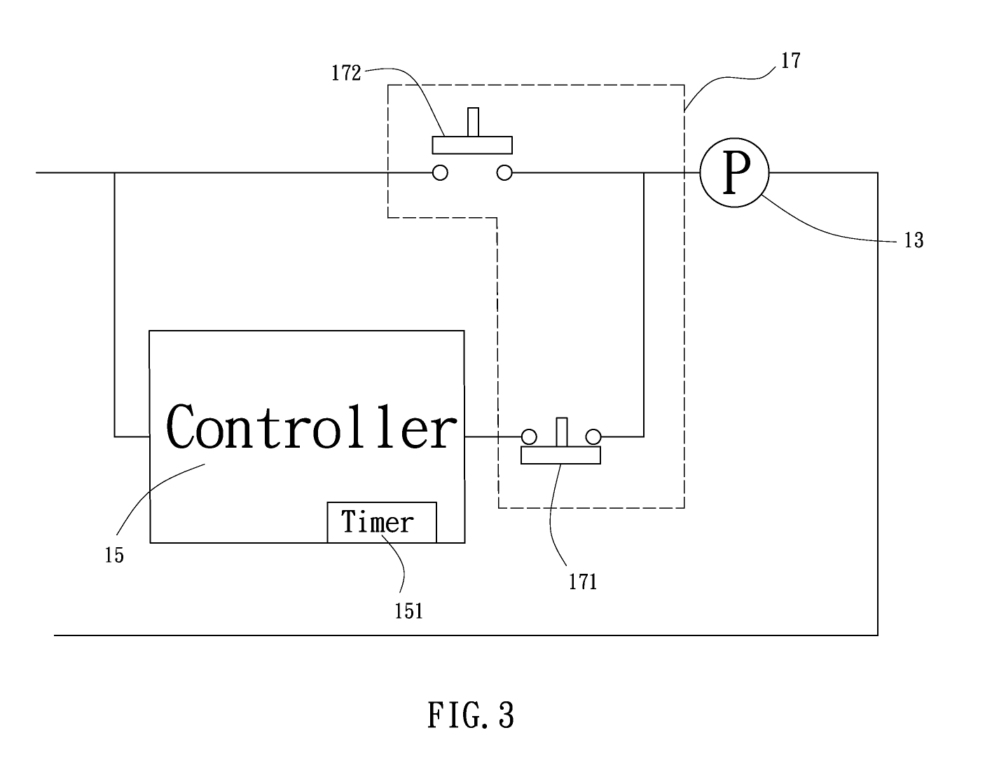

Please refer to FIGS. 1-3. The invention further includes a switch set 17 composed of a normally close switch 171 and a normally open switch 172. The normally open switch 172 connects to the pump 13 in series. The controller 15 connects to the normally close switch 171 in series and then connects to the normally open switch 172 in parallel. Usually, the switch set 17 will not be used but it has priority. The normally close switch 171 has priority when the working pump 13 needs to be stopped immediately. On the other hand, the normally open switch 172 has priority when the controller 13 malfunctions or the pump 13 needs to be started immediately.

Please refer back to FIG. 1. The container 12 has a cap 123 for sealing up the opening 122. And the container 12 is provided with a scale 124 for indicating saliva volume.

As shown in FIG. 7, the suction head 11 must be placed in lower jaw 18 of the mouth of a patient. The controller 15 may be used to turn on or off the pump 13 or associated with the sensor 16 and timer 151 for automatic control. When an emergency appears, the switch set 17 may be used to forcedly turn on or off the pump 13. Thus, the invention can be automatically or manually operated.

Such alterations, modifications, and improvements are intended to be part of this disclosure, and are intended to be within the spirit and the scope of the present invention. Accordingly, the foregoing description is by way of example only and is not intended to be limiting. The present invention is limited only as defined in the following claims and the equivalents thereto.

What is claimed is:

1. A saliva suction system comprising:
a suction head, having an outline fitting a lower jaw, provided with a plurality of inlet holes and an outlet hole, wherein the inlet holes communicate with the outlet hole;
a container;
a pump;
two tubes, separately disposed between the pump and the suction head and between the pump and the container; and
a controller for turning on or off the pump

2. The saliva suction system of claim 1, further comprising a sensor for detecting saliva and sending a signal to the controller.

3. The saliva suction system of claim 1, further comprising a sensor, wherein the controller continuously has the pump turn on when the sensor also continuously detects existence of saliva, and the controller instantly or delayedly turns off the pump when the sensor does not detect any saliva.

4. The saliva suction system of claim 1, wherein the controller has a timer by which an intermittent operation of the pump is performed.

5. The saliva suction system of claim 1, further comprising a switch set composed of a normally open switch and a normally close switch, wherein the normally open switch connects to the pump in series, the controller connects to the normally close switch in series and then connects to the normally open switch in parallel.

6. The saliva suction system of claim 1, wherein the suction head has a flat outline fitting the lower jaw of mouth.

7. The saliva suction system of claim 1, wherein the suction head is formed by an upper flat surface and a lower cambered surface, a front side and rear side of the suction head are formed with a recess and a rear convex arc respectively, a left side and right side of the suction head are formed with a left convex arc and a right convex arc respectively.

8. The saliva suction system of claim 1, wherein the suction head is made of silicone.

9. The saliva suction system of claim 1, wherein the controller has a display.

10. The saliva suction system of claim 2, wherein the sensor is a flow meter.
